(19) United States
(12) Patent Application Publication
(10) Pub. No.: US 2002/0188813 A1
(43) Pub. Date: Dec. 12, 2002

(54) On-chip hardware breakpoint generator with comprehensive memory operation detection

(76) Inventors: Hugo Cheung, Tucson, AZ (US); Terence Chiu, Tucson, AZ (US); Lu Yuan, Carlsbad, CA (US); Russell Y. Anderson, Saint David, AZ (US)

Correspondence Address: TEXAS INSTRUMENTS INCORPORATED, P O BOX 655474, M/S 3999, DALLAS, TX, 75265

(21) Appl. No.: 10/128,025

(22) Filed: Apr. 23, 2002

Related U.S. Application Data
(60) Provisional application No. 60/289,004, filed on May 4, 2001.

(51) Int. Cl. G06F 12/00

(52) U.S. Cl. 711/154

(57) ABSTRACT

An on-chip hardware breakpoint generator is disclosed. An embodiment of the present invention is configured to monitor accesses to various memory locations and to produce a breakpoint request when a predetermined memory access occurs. The memory access being monitored can be either a memory read or a memory write. Furthermore, the memory location being monitored can be a program memory location or a data memory location. A system for carrying out the invention may include a comparator coupled to a processor. The comparator is configured to sense when a memory access to a specific location occurs. When such an access occurs, the comparator forwards a signal to a breakpoint generator to implement a breakpoint.

### CROSS-REFERENCE TO RELATED APPLICATION

This application claims priority from U.S. Provisional Patent Application serial No. 60/289,004, filed May 4, 2001.

### FIELD OF INVENTION

The present invention relates to processors and more specifically to a system and method for generating breakpoints in a processor, including a microcontroller.

### BACKGROUND OF THE INVENTION

Microcontrollers are processors that may be used in a variety of applications, such as in appliances, computer peripherals, environmental control, instrumentation, aerospace, and a plethora of other areas in which a controller for specific functions is desired, but a full-function, stand-alone computer would be too large or power intensive to use. These microcontrollers may be self-contained products, containing a processor with memory, input and output means, timers, interrupt controller, etc., and the code that is to be executed by the processor. The code may be located in a programmable memory (such as EPROM, erasable programmable read-only memory) such that the code may be easily programmed into the system. The code may also be contained in a flash memory (such as EEPROM, electrically erasable programmable read-only memory) such that the code may be modified during the testing process. Embedded controllers are similar to microcontrollers and, in some contexts, the terms may be used interchangeably. Generally speaking, however, embedded controllers are not self-contained, e.g., an embedded controller may have an external memory, while microcontrollers are self-contained.

Although there are several architectures used in microcontrollers and other types of processors, the two main types of architectures used for microcontrollers are the Von Neumann architecture and the Harvard architecture. A Von Neumann architecture processor features a single data bus that is used to fetch both instructions and data: i.e., program instructions and data are stored in a common memory. On the other hand, the Harvard architecture processor features a separate data bus and a separate instruction bus. The Harvard architecture may have advantages with respect to speed: when a Von Neumann architecture controller addresses main memory, it first fetches an instruction, then fetches the data. In contrast, a Harvard architecture controller may allow instructions and data to be fetched simultaneously from the different memory buses.

Microcontrollers, as with other types of processors, typically use computer programs to direct the operations of the microcontroller. A computer program is a set of instructions (“code”) that is used to direct the operations of a processor or computer system. Those who create computer programs are generally called “programmers.”

When a programmer creates code to solve a particular problem, the programmer may follow a predetermined routine. For example, a programmer may start by determining, in broad terms, the steps that should be undertaken to solve the particular problem. Thereafter, the programmer may program the code needed to carry out the various steps. After the coding is finished, the program must be tested to ensure the proper operation of the program in a variety of conditions. The process of testing is often termed “debugging.”

There are several different methods that may be used to debug a computer program. One method involves using breakpoints at various points in the execution of a program. A breakpoint pauses or stops the execution of a program at the point at which the breakpoint is located. Breakpoints may be handled by a breakpoint monitor code (also known as a breakpoint service routine). When a breakpoint is encountered, control of the processor is turned over to the breakpoint monitor code. The breakpoint monitor code contains the logic that enables a tester to view the contents of certain locations.

One may use a breakpoint to determine what values are stored in certain locations (e.g., memory locations and register locations). A simple example may involve an assembly language program; one may wish to insert a breakpoint into a program after an instruction such as:

MOV R1, [MEM1]

The result of the above instruction is that the contents of memory location MEM1 is loaded into register R1. A breakpoint placed after the execution of the above instruction stops the execution of the program. By examining the contents of register R1 immediately after the execution of the above instruction, one may determine the value of R1 and thus determine the value of MEM1. If the value of MEM1 differs from the expected value, the tester has an indication that the program is not operating as intended and the tester may re-program certain portions of the code until the correct results are obtained.

Another method of using breakpoints is to determine how a program reacts in a given circumstance. After a program is stopped using a breakpoint, memory and register locations may be modified by storing desired values in specific locations. In this manner, one may determine how a program reacts in unusual circumstances or how a program reacts when processing certain data.

Once the breakpoint application is finished examining the processor and memory, the program may be resumed from the point at which it was stopped, with the processor in the same state it was operating in before the breakpoint was asserted. Through the judicious use of one or more breakpoints, one may determine if a program is operating in the intended manner in a variety of different circumstances.

It may be relatively easy to test software in a traditional “desktop” or “workstation” computer system. The code being tested is readily accessible to programmers and testers and may be easily changed with the traditional keyboard/monitor/mouse interface. There are also a number of utilities that may be used to debug a program. Many of those utilities contain a breakpoint feature. However, debugging programs in the context of microcontrollers may not be as simple. In order to adequately test the code in a microcontroller, one may find it desirable to test the code in the microcontroller as it will be used.

The start of a breakpoint service routine may be accomplished by using a “firmware” method of breakpoint generation. In the firmware method, existing lines of code are replaced by an instruction directing the program to the location of the breakpoint routine such that the breakpoint routine is executed instead of the program being tested. For example, the format of a 3-byte instruction for an exemplary processor may be as follows:

| | |
|---|---|
| A1: | Opcode |
| A2: | Operand 1 |
| A3: | Operand 2 |

where each of address A1, A2, and A3 are 1-byte memory locations.

In this example, the Opcode is an instruction to be performed while Operand 1 and Operand 2 indicate what is being affected by the instructions. For example, an instruction such as:

ADD R1, R3

contains an operand, ADD, which indicates what operation is to be performed. R1 and R3 indicate what is being affected. In this case, the contents of register-R1 and register R3 are being added together and the result is stored in a predetermined location.

In the firmware method of breakpoint generation, the above instructions would be replaced by the following 3-byte instruction:

| | |
|---|---|
| A1: | JMP |
| A2: | Addr1 |
| A3: | Addr2 |

The JMP instructions directs the operation of the code to the breakpoint routine that is located at the 16-bit address indicated by Addr1, Addr2.

There are limitations to the firmware method: no breakpoint request may be generated on data memory accesses using this replacement method as breakpoints are only used in program memory accesses; breakpoints may only be generated at certain address locations, such as address A1 in the above example; inserting a JMP opcode at address A2 or A3 may confuse the processor because it is expecting an operand for the opcode at address A1; and it is desirable that the JMP operation not replace an instruction that is longer or shorter than three bytes in length. Furthermore, the firmware method is considered intrusive because the original code must be modified by replacing three memory locations containing opcode/operands with a JMP opcode and address location. When testing code, it is desirable to test, unaltered, the code that will be used in production to ensure that the code is operating properly.

In addition, for a Harvard architecture controller, only breakpoint generation in a program memory space is typically used: breakpoint generation is very difficult to perform in a data memory space. However, it may be desirable, for example, to have a breakpoint asserted each time a certain memory location is accessed to determine if the memory location contains the correct value.

The firmware method may also become time consuming. In order to substitute a JMP instruction for the existing instruction, the tester must erase the existing program, which resides in an erasable memory chip, and replace it with the new program. The time needed to modify a new program every time a different breakpoint location is desired may be detrimental to the development time of microcontrollers.

Because of these and other limitations to the firmware method of implementing breakpoints, hardware implementations of breakpoints have been developed. One such hardware implementation utilizes the Joint Test Action Group/Built-in Debug Module (JTAG/BDM) method. The JTAG developed a standard for testing circuitry that was sanctioned by the Institute for Electrical and Electronic Engineers (IEEE) as IEEE Standard 1149.1: Test Access Port and Boundary-Scan Architecture.

An IEEE 1149.1 compliant device uses the boundary scan feature, which allows various pins of the Integrated Circuit (“IC”) to be controlled and observed through the IEEE 1149.1 interface. IEEE 1149.1 allows an IC, a board, or a system to be controlled or monitored via a standard 4-wire interface, through the use of the boundary scan feature.

In addition to the IEEE 1149.1 interface and the boundary-scan architecture, there are other test/debug interfaces that may be implemented. Among these interfaces is the Built-in Debug Module (BDM). The BDM allows a hardware controller within the BDM to take over the control of the processor. Thus, the JTAG/BDM method is non-intrusive, because no code has to be modified. However, the JTAG/BDM method also suffers from various limitations.

A JTAG/BDM implementation which determines whether the Breakpoint request was generated by a data memory access or a program memory access. In addition, the implementation of JTAG/BDM requires 4 pins dedicated to JTAG/BDM. With the small size of a typical microcontroller, the loss of 4 pins with which to transmit and receive data or power may be detrimental, and is especially inappropriate for low pin count devices. Furthermore, a JTAG/BDM circuit requires circuitry to perform its functions. That means many additional transistors on the controller, increasing the size of the controller as well as the cost. The circuitry needed to operate the breakpoint service routine also adds to the size and cost of the controller.

In addition, when used in a breakpoint environment, there are several other possible disadvantages. A user may wish to change a portion of the breakpoint program, e.g., by changing breakpoint locations, the data (both memory and registers) being viewed at a breakpoint, or the format of the data output by the breakpoint routine. However, because the breakpoint is implemented in hardware, changing the breakpoint program hardware may be a time-consuming task because of the necessity of changing the hardware (for example, by reprogramming the hardware by loading a new program in a memory). For example, a breakpoint routine may examine certain registers but not others. Changing the breakpoint routine hardware to examine other registers may be too difficult or time consuming to make such a change worthwhile to one testing the system.

Several of the above listed limitations, as well as other limitations, are detailed in the Texas Instruments document titled Design Tradeoffs When Implementing IEEE 1149.1, the contents of which are incorporated by reference.

### SUMMARY OF THE INVENTION

The device according to the present invention addresses many of the shortcomings of the prior art. In accordance with various aspects of the present invention, an improved breakpoint scheme is configured to provide a user with a more flexible breakpoint implementation. In accordance with an exemplary embodiment, the address lines of a processor are monitored to determine if a predetermined memory location is accessed. When that situation occurs, a breakpoint interrupt request is issued. In a Harvard Architecture system, the memory location being monitored can be either the program memory or the data memory. In such a manner, the execution of a program can be monitored either when a specific memory location is accessed or when a specific program instruction is executed. In addition, the memory location being monitored may be either a memory location being written to a memory being read from.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1, illustrates a block diagram of the layout of an exemplary embodiment of the present invention;

FIG. 2 shows a portion of FIG. 1 in further detail;

FIG. 3 shows the enable and disable control of the BPIRQ signal;

FIG. 4 shows an exemplary embodiment of the present invention; and

FIG. 5 illustrates a block diagram of an exemplary microcontroller in accordance with an exemplary embodiment of the present invention.

### DETAILED DESCRIPTION

The present invention may be described herein in terms of various functional components and various processing steps. It should be appreciated that such functional components may be realized by any number of hardware or structural components configured to perform the specified functions. For example, while the invention is described in the context of a microcontroller with a Harvard Architecture microcontroller, it should be understood that the present invention is also operable with microcontrollers of other architectures. In addition, the present invention is not limited to microcontrollers, as the present invention may be generally used with any type of processor. Further, it should be noted that, while various components may be suitably coupled or connected to other components within exemplary circuits, such connections and couplings may be realized by direct connection between components, or by connection through other components and devices.

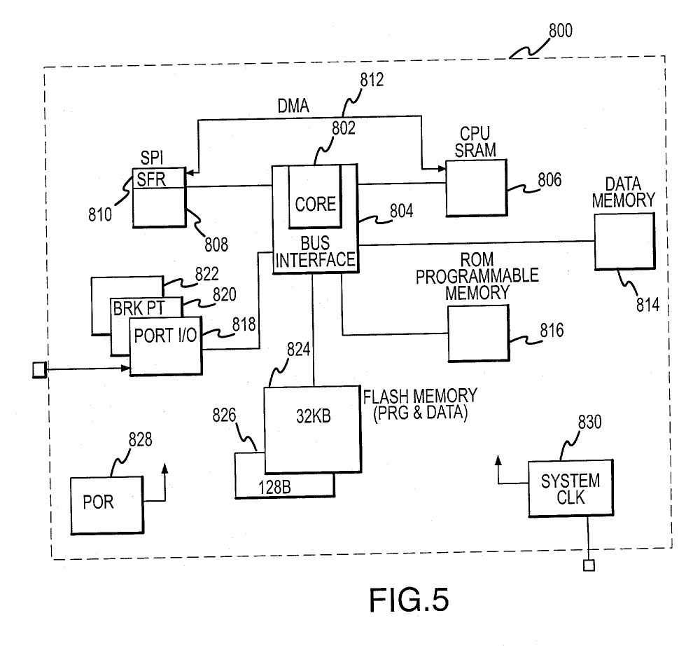

With reference to FIG. 5, an exemplary microcontroller 800 is illustrated. Microcontroller 800 suitably comprises a central processing unit (CPU) core 802 configured for the processing of data, and a bus interface 804 for communication with the various memory or input and output devices. For the storage of data, microcontroller 800 may contain various types of memory. For example, microcontroller 800 may comprise an internal static random access memory (SRAM) 806 which may provide very low access time, e.g., as low as 10 nanoseconds. In addition, Microcontroller 800 may also include data memory 814 which may also comprise SRAM-type memory, and read-only memory (ROM) 816 which may comprise the programmable memory for the Microcontroller 800. Still further, Microcontroller 800 may also include flash memory for the programming and storage of data, such as a page of memory 824 comprising, for example, 32 kilobytes of data storage, as well as a smaller configuration of flash memory 826. For the transmitting and receiving of data between various components, microprocessor 800 may also include serial peripheral interface (SPI) 810 which may communicate with the CPU memory 806 via direct memory access (DMA) 812, i.e., SPI 808 may transfer data from main memory to a device without passing the data through the CPU.

In addition, the microcontroller may also include various input/output devices. For example, an I/O port device 818 may be provided, as well as a breakpoint device 820. Further, microcontroller 800 may also include a system clock 830 for providing clock cycles for triggering various functions and sequences during operation. Microcontroller 800 may also include a Power On Reset (POR) 828 for use during ramping up of a power supply.

As discussed above, previous implementations of breakpoints suffered from various limitations, including an inability to trigger a breakpoint routine during accesses to data memory. However, in accordance with various aspects of the present invention, an improved breakpoint scheme is configured to provide a more flexible breakpoint implementation.

In accordance with an exemplary embodiment, to solve the above problems, an exemplary microcontroller having a breakpoint generator may be programmed with a predetermined memory location. The memory bus lines may then be monitored to determine which memory locations are being accessed at any particular time. When a request is made to the predetermined memory location, a breakpoint interrupt request may issue. In a Harvard Architecture system, this may occur whether the memory location is data memory or program memory. In addition, the monitor features are not limited to JTAG/BDM hardware implementation. Thus, the amount of circuitry needed is less than that needed by a JTAG/BDM controller. In addition, with an embodiment of the present invention, it is not necessary to dedicate four pins to a JTAG/BDM controller when using an embodiment of the present invention, as the existing input/output pins may be used. In addition, an embodiment of the present invention may be configured to distinguish between read and write access. The above advantages result in a more flexible approach to breakpoint generation.

There may be various methods employed to monitor memory accesses. One exemplary embodiment utilizes a comparator circuit that monitors predetermined pins of the microcontroller (e.g., the pins indicating the memory address being accessed). When a particular address is sensed on the monitored pins, an interrupt request is generated and sent to the microcontroller. The interrupt request results in the start of a breakpoint service routine.

One wishing to debug a certain area of memory would program the comparator with the memory location to be monitored. When that memory location is reached, a breakpoint interrupt may be asserted.

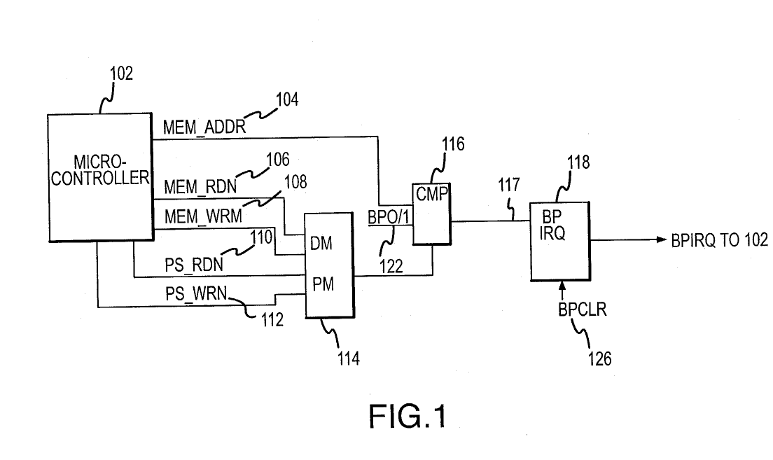

With reference to FIG. 1, the layout of an exemplary embodiment of the present invention, when used in conjunction with a Harvard Architecture system, is presented. Microcontroller 102 is shown with several of its outputs: MEM_ADDR 104 is the memory address currently being accessed by microcontroller 102; MEM_RDN 106 is a pin that is active when a read from a data memory location is being performed; MEM_WRN 108 is a pin that is active when a write to a data memory location is being performed; PS_RDN 110 is a pin that is active when a read from a program memory location is being performed; and PS_WRN 112 is a pin that is active when a write to a program memory location is being performed. It should be understood that, in certain embodiments, only one of pins 106, 108, 110, and 112 may be active at any one time. Comparator 114 is configured to determine whether an access is made to the data memory space or to the program memory space and transmit the result to comparator 116. Comparator 116 may be loaded with a particular memory location and a type of data access (read from data memory, write to data memory, read from program memory, or write to program memory). Comparator 116 may also contain an input 122 that determines whether or not breakpoints are activated. By changing the value of input 122, one testing a microcontroller may disable the breakpoint feature, if so desired.

When a predetermined memory address is sensed on MEM_ADDR 104 (by comparator 116) and a sought after type of memory access is sensed by comparator 114, a breakpoint interrupt request (“BPIRQ”) is sent to microcontroller 102. The microcontroller remains under the control of the break request until a breakpoint clear signal is sent to port BPCLR 120, indicating that the break routine is finished.

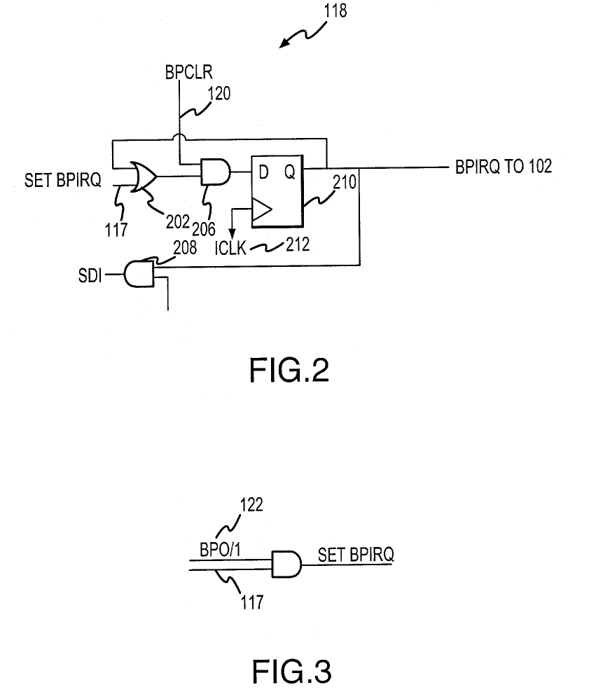

With reference to FIG. 2, a schematic drawing an exemplary embodiment of circuit 118, which generates a BPIRQ signal, is presented. In this exemplary embodiment, circuit 118 comprises an OR gate 202, an AND gate 206, an AND gate 208, and a flip-flop 210. Signal 117 from comparator 116 indicates the need to set the BPIRQ flag. Once set, the signal passes through the OR gate 202 (any high input results in a high output of OR gate 202) to AND gate 206, the function of which will be further detailed below. The output of AND gate 206 propagates to flip-flop 210. At the next high transition of clock 212, the output of flip-flop 210 becomes high and the BPIRQ signal is sent to microcontroller 102. The other input to OR gate 202 is the output from flip-flop 210. This input acts as a feedback signal to maintain the value of BPIRQ until cleared by setting BPCLR low.

AND gate 206 has two inputs, one from OR gate 202 and the BPCLR signal 120. BPCLR signal 120 is responsible for clearing the BPIRQ signal. This signal is set by the microcontroller 102. When the BPCLR signal is high, the signal from OR gate 202 is transmitted to flip-flop 210. However, when the BPCLR signal is low, the input to the flip-flop 210 is forced low, thus clearing the breakpoint. In this manner, BPCLR can act to keep BPIRQ low (not allowing an interrupt request to occur), even if the desired memory location is accessed.

FIG. 3 shows the enable and disable control of the SET BPIRQ signal. When the breakpoint generator is activated, the signal BP0/1 122 is set, thus the output of the comparator signal 117 is propagated to the signal SET BPIRQ through the AND gate. Otherwise, the SET BPIRQ signal is always forced low.

Co-pending U.S. patent application Ser. No. 10/017,179, filed on Dec. 14, 2001 and assigned to the assignee of the present application, discloses the use of a memory space for breakpoint monitor code that is separate from the memory space for the application code. A hardware dynamic memory mapping controller (“DMmap”) is used to direct requests from memory to the appropriate memory space.

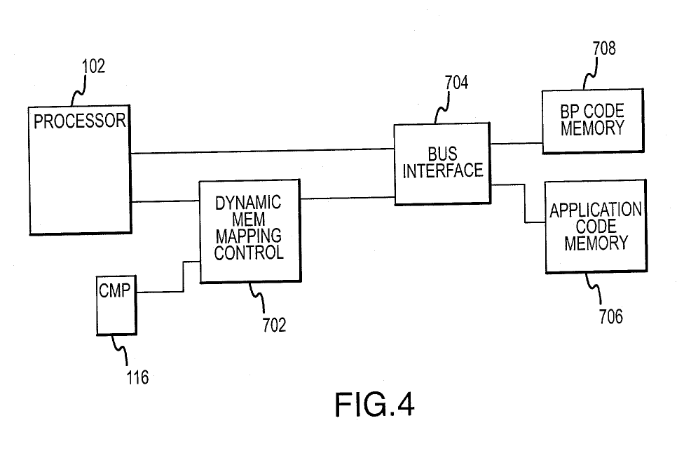

FIG. 4 shows an embodiment of the present invention used with an embodiment of the invention disclosed in the '179 patent application. Processor 102 and breakpoint generator 118 are both coupled to a dynamic memory mapping controller 702. In addition, both processor 102 and dynamic memory mapping controller 702 are coupled to bus interface 704. Bus interface 704 is coupled to both application code memory space 706 and breakpoint monitor code memory space 708.

In operation, processor 102 accesses the application code memory space 706 or breakpoint monitor code memory space 708 through bus interface 704. At the appropriate time, e.g., when a specific memory address is accessed, breakpoint generator 118 generates a breakpoint signal that propagates to dynamic memory mapping controller 702, which may be configured to send a signal to bus interface 704. Bus interface 704 switches in breakpoint monitor code memory space 708 for application code memory space 706 when indicated by an interrupt request. Within the breakpoint interrupt service routine (“BPISR”), processor 102 executes commands from the debugging host. At the end of the BPISR, CRB is set to inform DMmap that control flow is released.

An embodiment of the present invention may have a limited number of comparators inside the breakpoint generator, and thus a limited number of available different breakpoints. For example, if there are two comparators, there may only be two breakpoints set under this method. In the event that a user wishes to have more breakpoints than there are comparators, the present invention may be combined with the firmware method of implementing breakpoints. Although the various disadvantages of the firmware method described above may still remain, the user would be able to lessen the amount of the intrusion caused by modifying the source code on the microcontroller by lessening the modification of the source code.

The above description presents exemplary modes contemplated in carrying out the invention. The techniques described above are, however, susceptible to modifications and alternate constructions from the embodiments shown above. Other variations and modifications of the present invention will be apparent to those of ordinary skill in the art, and it is the intent of the appended claims that such variations and modifications be covered. For example, the above-described system may be used in either a Harvard Architecture system or a Von Neumann Architecture system.

Consequently, it is not the intention to limit the invention to the particular embodiments disclosed. On the contrary, the invention is intended to cover all modifications and alternate constructions falling within the scope of the invention, as expressed in the following claims when read in light of the description and drawings. No element described in this specification is necessary for the practice of the invention unless expressly described herein as “essential” or “required.”

We claim:

1. A method of using on-chip breakpoints in a microprocessor system comprising:
monitoring the memory accesses of the microprocessor; and
sending a breakpoint request signal to the microprocessor, wherein
said monitoring step is configured to determine whether a predetermined type of memory access has occurred;
said sending step is conditioned upon whether the predetermined type of memory access has occurred; and
said predetermined type of memory access includes memory reads and memory writes.

2. The method of claim 1 wherein said predetermined types of memory accesses further includes data memory and program memory.

3. The method of claim 1 wherein said monitoring step is further configured to determine whether a predetermined memory address is being accessed.

4. The method of claim 1 wherein said breakpoint request signal is configured to initiate a breakpoint process in said microprocessor system.

5. The method of claim 1 wherein said sending step is configured to occur upon the detection of a predetermined memory access.

6. The method of claim 5 wherein said predetermined memory access comprises a type of memory access and a specific memory location.

7. A system for implementing breakpoints in a microcontroller, said system comprising:
a first comparator coupled to said microcontroller, said first comparator configured to monitor types of memory accesses by said microcontroller and to generate signals indicating the type of memory access;
a second comparator coupled to said microcontroller, said second comparator configured to monitor the memory location being accessed, provide an indication if a predetermined memory location is being accessed, and generate signals corresponding to said indication; and
a breakpoint interrupt generator coupled to said first and second comparators, said breakpoint interrupt generator configured to send a breakpoint interrupt request to said microcontroller based on signals generated by said first and second comparators.

8. The system of claim 7 wherein said breakpoint interrupt generator comprises:
a flip-flop coupled to said comparator, said flip-flop configured to generate a breakpoint synchronous with a clock.

9. The system of claim 7 further comprising;
a breakpoint enable signal coupled to said breakpoint interrupt generator, wherein said breakpoint enable signal is configured to enable or disable said breakpoint interrupt generator based on the value of said breakpoint enable signal.

10. The system of claim 9 further comprising an AND gate, wherein
said AND gate is coupled to said breakpoint enable signal and said AND gate is also coupled to said second comparator.

11. The system of claim 7 further comprising an AND gate, wherein
said AND gate is coupled to said first comparator and said second comparator.

12. The system of claim 7 wherein said breakpoint interrupt generator comprises:

13. A system for implementing breakpoints in a microcontroller, said system comprising:
a breakpoint interrupt generator configured to transmit signals when a breakpoint is desired;
a dynamic memory mapping controller coupled to said breakpoint interrupt generator and to said microcontroller;
a bus interface coupled to said microcontroller and to said dynamic memory mapping controller;
a breakpoint memory coupled to said bus interface; and
a program memory coupled to said bus interface, wherein,
said bus interface is configured to select between said program memory and said breakpoint memory based on a signal from said breakpoint interrupt generator.

14. The system of claim 13 wherein
said breakpoint interrupt generator is configured to transmit signals indicative of a breakpoint upon an access of a predetermined memory location.
